(19) United States
(12) Patent Application Publication
(10) Pub. No.: US 2022/0394763 A1
(43) Pub. Date: Dec. 8, 2022

(54) METHODS AND APPARATUS FOR INDICATING A FAILURE EVENT

(71) Applicant: Telefonaktiebolaget LM Ericsson (publ), Stockholm (SE)

(72) Inventor: Min Wang, Luleå (SE)

(21) Appl. No.: 17/773,630

(22) PCT Filed: Jun. 22, 2020
(86) PCT No.: PCT/EP2020/067351

§ 371 Date: May 2, 2022

(30) Foreign Application Priority Data
Nov. 5, 2019 (EP) PCT/EP2019/080273

(51) Int. Cl. H04W 74/08; H04W 24/04

(52) U.S. Cl. CPC H04W 74/0808; H04W 24/04

(57) ABSTRACT

Methods and apparatus for indicating a failure event are disclosed. According to an embodiment, a terminal device determines a message including at least one indication which indicates at least one failure event. The terminal device further transmits the message to a network node.

### TECHNICAL FIELD

Embodiments of the disclosure generally relate to wireless communication, and, more particularly, to methods and apparatus for indicating a failure event.

### BACKGROUND

This section introduces aspects that may facilitate better understanding of the present disclosure. Accordingly, the statements of this section are to be read in this light and are not to be understood as admissions about what is in the prior art or what is not in the prior art.

The 5th generation of cellular system, called New Radio (NR) is developed for maximum flexibility to support multiple and substantially different use cases. Besides the typical mobile broadband use case, also machine type communication (MTC), ultra-low latency critical communications (URLCC), side-link device-to-device (D2D) and several other use cases too.

In NR, the basic scheduling unit is called a slot. A slot consists of 14 Orthogonal frequency-division multiplexing (OFDM) symbols for the normal cyclic prefix configuration. NR supports many different subcarrier spacing (SCS) configurations and at a subcarrier spacing of 30 kHz the OFDM symbol duration is about 33 us. As an example, a slot with 14 symbols for the same SCS is 500 us long (including cyclic prefixes).

NR also supports flexible bandwidth configurations for different user equipments (UEs) on the same serving cell. In other words, the bandwidth monitored by a UE and used for its control and data channels may be smaller than the carrier bandwidth. One or multiple bandwidth part (BWP) configurations for each component carrier can be semi-statically signaled to a UE, where a bandwidth part consists of a group of contiguous PRBs. Reserved resources can be configured within the bandwidth part. The bandwidth of a bandwidth part equals to or is smaller than the maximal bandwidth capability supported by a UE.

NR is targeting both licensed and unlicensed bands. Allowing unlicensed networks, i.e., networks that operate in shared spectrum (or unlicensed spectrum) to effectively use the available spectrum is an attractive approach to increase system capacity. Although unlicensed spectrum does not match the qualities of the licensed regime, solutions that allow an efficient use of it as a complement to licensed deployments have the potential to bring great value to the operators, and, ultimately, to the industry as a whole. It is expected that some features in NR will need to be adapted to comply with the special characteristics of the unlicensed band as well as also different regulations. A subcarrier spacing of 15 or 30 kHz are the most promising candidates for NR-unlicensed (NR-U) OFDM numerologies for frequencies below 6 GHz.

When operating in unlicensed spectrum many regions in the world require a device to sense the medium as free before transmitting, this operation is often referred to as listen before talk or LBT for short. LBT is designed for unlicensed spectrum co-existence with other radio access technologies (RATs). In this mechanism, a radio device applies a clear channel assessment (CCA) check (i.e. channel sensing) before any transmission. The transmitter involves energy detection (ED) over a time period compared to a certain threshold (ED threshold) in order to determine if a channel is idle. In case the channel is determined to be occupied, the transmitter performs a random back-off within a contention window before next CCA attempt. In order to protect the acknowledgement (ACK) transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). Prior to any transmission in the uplink, the UE may need to perform the LBT operation to grasp the channel. For instance, the media access control (MAC) layer initiates a transmission, the MAC layer requests the physical (PHY) layer to initiate the LBT operation, the PHY layer further sends an indicator to the MAC indicating the LBT outcome (i.e., success or failure). For quality of service (QoS) differentiation, a channel access priority based on the service type has been defined. For example, there are four LBT priority classes for differentiation of contention window sizes (CWS) and MCOT between services. There are many different flavors of LBT, depending on which radio technology the device uses and which type of data it wants to transmit at the moment. Common for all flavors is that the sensing is done in a particular channel (corresponding to a defined carrier frequency) and over a predefined bandwidth. For example, in the 5 GHz band, the sensing is done over 20 MHz channels.

In principle, there are two ways a device can operate over multiple sub-bands. One way is that the transmitter/receiver bandwidth is changed depending on which sub-bands that were sensed as free. In this setup, there is only one component carrier (CC) and the multiple sub-bands are treated as single channel with a larger bandwidth. The other way is that the device operates almost independent processing chains for each channel. Depending on how independent the processing chains are, this option can be referred to as either carrier aggregation (CA) or dual connectivity (DC).

Many devices are capable of transmitting and receiving over a wide bandwidth including of multiple sub-bands/channels, e.g., LBT sub-band (i.e., the frequency part with bandwidth equals to LBT bandwidth). A device is only allowed to transmit on the sub-bands where the medium is sensed as free. Again, there are different flavors of how the sensing should be done when multiple sub-bands are involved.

One of the main intentions of radio link failure (RLF) procedure was to assist the UE to perform a fast and reliable recovery without going via the idle state, e.g. radio resource control idle (RRC_IDLE) state. It is beneficial to avoid unnecessary latency due to the random access channel (RACH) access and radio resource control (RRC) connection establishment from RRC_IDLE. The radio link monitoring of the serving cell followed by RRC re-establishment to the target cell is illustrated in FIG. 1.

There are several reasons that may lead to the radio link failure, including:

(1) Timer T310 expiry

While the UE is in RRC connected mode, the UE monitors the downlink radio channel quality based on the downlink reference symbol. The UE compares the measured downlink channel quality with the out-of-sync and in-sync thresholds (Qout and Qin) respectively. The physical channel evaluates the downlink channel quality, periodically sends indication on out-of-sync or in-sync to layer 3. The UE layer 3 then evaluates if the radio link failure based on the in-sync and out-of-sync indications, that output from the layer 3 filter. When the consecutively received out-of-sync indications are beyond the counter N310, a timer T310 is started. While T310 is running, the radio link considered to be recovered if the UE consecutively receives N311 in-sync indications from the physical layer.

When the timer T310 is expired, a radio link failure is declared by the UE.

(2) Maximum number of radio link control (RLC) retransmissions in uplink is reached

(3) Handover failure and timer T304 expiry

During handover procedure, the timer T304 is started when the UE receives a handover command from the source cell, the value of the timer T304 should be set to allow the UE to try the maximum RACH access attempts to the target cell. When the timer T304 is expired, a radio link failure due to handover is detected.

When a radio link failure is triggered, the radio connection re-establishment is triggered. A UE shall first perform cell search to determine the best cell for radio link re-establishment. According to 3GPP technical specification (TS) 36.300 V15.7.0, a UE can select the same cell, a different cell from the same evolved Node B (eNB), or a prepared cell from a different eNB, wherein the activity can be resumed (i.e., the UE stays in connected mode) via radio connection re-establishment procedure since the previous UE context can be retrieved by inter-cell communication. However, when a prepared cell is not available, the UE selects an unprepared cell. In this case, the UE has to go to idle mode and try to setup the radio connection afterwards. In this case, activity of the UE cannot be resumed. Table 1, which is Table 10.1.6-1 from 3GPP TS36.300 V15.7.0, guides the UE behavior for target cell selection, which is cited here.

TABLE 1
Mobility and Radio Link Failure

| Cases | First Phase | Second Phase | T2 expired |
|---|---|---|---|
| UE returns to the same | Continue as if no | Activity is resumed by | Go via RRC_IDLE |
| cell | radio problems | means of explicit signalling | |
| | occurred | between UE and eNB | |
| UE selects a different | N/A | Activity is resumed by | Go via RRC_IDLE |
| cell from the same eNB | | means of explicit signalling | |
| | | between UE and eNB | |
| UE selects a cell of a | N/A | Activity is resumed by | Go via RRC_IDLE |
| prepared eNB (NOTE) | | means of explicit signalling | |
| | | between UE and eNB | |
| UE selects a cell of a | N/A | Go via RRC_IDLE | Go via RRC_IDLE |
| different eNB that is not | | | |
| prepared (NOTE) | | | |

(NOTE):
a prepared eNB is an eNB which has admitted the UE during an earlier executed HO preparation phase, or obtains the UE context during the Second Phase.

The MAC entity may be configured by RRC with a beam failure recovery procedure which is used for indicating to the serving (next) generation Node B (gNB) of a new synchronization signal block (SSB) or channel state information reference signal (CSI-RS) when beam failure is detected on the serving SSB(s)/CSI-RS(s). Beam failure is detected by counting beam failure instance indication from the lower layers to the MAC entity. According to clause 5.17 in 3GPP TS 38.321 V15.7.0, which is cited here, the MAC entity shall:

1> if beam failure instance indication has been received from lower layers:
2> start or restart the beamFailureDetectionTimer;
2> increment BFI_COUNTER by 1;
2> if BFI_COUNTER>=beamFailurelnstanceMaxCount:
   3> if beamFailureRecoveryConfig is configured:
      4> start the beamFailureRecoveryTimer, if configured;
      4> initiate a Random Access procedure on the SpCell by applying the parameters powerRampingStep, preambleReceivedTargetPower, and preambleTransMax configured in beamFailureRecoveryConfig.
   3> else:
      4> initiate a Random Access procedure on the SpCell.

1> if the beamFailureDetectionTimer expires:
2> set BFI_COUNTER to 0.

1> if the Random Access procedure is successfully completed:
2> stop the beamFailureRecoveryTimer, if configured;

2> consider the Beam Failure Recovery procedure successfully completed.

The Scheduling Request (SR) is used for requesting uplink shared channel (UL-SCH) resources for new transmission.

The MAC entity may be configured with zero, one, or more SR configurations. An SR configuration consists of a set of physical uplink control channel (PUCCH) resources for SR across different BWPs and cells. For a logical channel, at most one PUCCH resource for SR is configured per BWP.

Each SR configuration corresponds to one or more logical channels. Each logical channel may be mapped to zero or one SR configuration, which is configured by RRC.

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled. All pending SR(s) triggered prior to the MAC PDU assembly shall be cancelled and each respective timer (e.g. sr-ProhibitTimer) shall be stopped when the MAC protocol data unit (PDU) is transmitted and this PDU includes a buffer status report (BSR) MAC control element (CE) which contains buffer status up to and including the last event that triggered a BSR prior to the MAC PDU assembly. All pending SR(s) shall be cancelled when the uplink (UL) grant(s) can accommodate all pending data available for transmission.

Only PUCCH resources on a BWP which is active at the time of SR transmission occasion are considered valid.

According to clause 5.4.4 in 3GPP TS 38.321 V15.7.0, which is cited here, as long as at least one SR is pending, the MAC entity shall for each pending SR:
1> if the MAC entity has no valid PUCCH resource configured for the pending SR:
   2> initiate a Random Access procedure on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap; and
   2> if the PUCCH resource for the SR transmission occasion does not overlap with a UL-SCH resource:
      3> if SR_COUNTER<sr-TransMax:
         4> increment SR_COUNTER by 1;
         4> instruct the physical layer to signal the SR on one valid PUCCH resource for SR;
         4> start the sr-ProhibitTimer.
      3> else:
         4> notify RRC to release PUCCH for all Serving Cells;
         4> notify RRC to release SRS for all Serving Cells;
         4> clear any configured downlink assignments and uplink grants;
         4> initiate a Random Access procedure on the SpCell and cancel all pending SRs.
NOTE: The selection of which valid PUCCH resource for SR to signal SR on when the MAC entity has more than one overlapping valid PUCCH resource for the SR transmission occasion is left to UE implementation.

The MAC entity may stop, if any, ongoing random access procedure due to a pending SR which has no valid PUCCH resources configured, which was initiated by MAC entity prior to the MAC PDU assembly. Such a random access procedure may be stopped when the MAC PDU is transmitted using a PDU grant other than a UL grant provided by random access response, and this PDU includes a BSR MAC CE which contains buffer status up to and including the last event that triggered a BSR prior to the MAC PDU assembly, or when the UL grant(s) can accommodate all pending data available for transmission.

According to section 6.1.2 of 3GPP TS 38.321 V15.7.0, a media access control (MAC) protocol data unit (PDU) consists of one or more MAC subPDUs. Each MAC subPDU consists of one of the following: 1) a MAC subheader only (including padding); 2) a MAC subheader and an MAC service data unit (SDU); 3) a MAC subheader and an MAC control element (CE); 4) a MAC subheader and padding. The MAC SDUs are of variable sizes. Each MAC subheader corresponds to either a MAC SDU, a MAC CE, or padding.

A MAC subheader except for fixed sized MAC CE, padding, and an MAC SDU containing uplink (UL) common control channel (CCCH) consists of four header fields R/F/LCID/L, as shown in FIG. 2A (with 8-bit L field) and FIG. 2B (with 16-bit L field). A MAC subheader for fixed sized MAC CE, padding, and a MAC SDU containing UL CCCH consists of two header fields R/LCID, as shown in FIG. 2C.

In FIGS. 2A-2C, the Logical Channel ID (LCID) field refers to logical channel identity (ID) field. It identifies the logical channel instance of the corresponding MAC SDU or the type of the corresponding MAC CE or padding as described in Tables 6.2.1-1 and 6.2.1-2 (of 3GPP TS 38.321 V15.7.0) for the downlink-shared channel (DL-SCH) and uplink-shared channel (UL-SCH) respectively. There is one LCID field per MAC subheader. The LCID field size is 6 bits. The L field refers to Length field and indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field. The F field refers to the Format field and indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field. The R field refers to reserved bit and is set to zero. The MAC subheader is octet aligned.

The following two tables show the values of the defined LCID for DL-SCH and UL-SCH in 3GPP TS 38.321 V15.7.0.

TABLE 2
Values of LCID for DL-SCH

| Index | LCID values |
|---|---|
| 0 | CCCH |
| 1-32 | Identity of the logical channel |
| 33-46 | Reserved |
| 47 | Recommended bit rate |
| 48 | SP ZP CSI-RS Resource Set |
| | Activation/Deactivation |
| 49 | PUCCH spatial relation |
| | Activation/Deactivation |
| 50 | SP SRS Activation/Deactivation |
| 51 | SP CSI reporting on PUCCH |
| | Activation/Deactivation |
| 52 | TCI State Indication for UE-specific |
| | PDCCH |
| 53 | TCI States Activation/Deactivation for UE- |
| | specific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 3
Values of LCID for UL-SCH

| Index | LCID values |
|---|---|
| 0 | CCCH of size 64 bits (referred to as |
| | “CCCH1” in TS 38.331 [5]) |
| 1-32 | Identity of the logical channel |
| 33-51 | Reserved |
| 52 | CCCH of size 48 bits (referred to as |
| | “CCCH” in TS 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

MAC CEs are placed together. DL MAC subPDU(s) with MAC CE(s) is placed before any MAC subPDU with MAC SDU and MAC subPDU with padding as depicted in FIG. 3A. UL MAC subPDU(s) with MAC CE(s) is placed after all the MAC subPDU(s) with MAC SDU and before the MAC subPDU with padding in the MAC PDU as depicted in FIG. 3B. The size of padding can be zero.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Layer 2 LBT failure mechanism may take into account any LBT failure regardless UL transmission type. The UL LBT failure mechanism may have the same recovery mechanism for all failures regardless UL transmission type. UL LBT failures may be detected per BWP. The UE will report the occurrence of consistent UL LBT failures on primary secondary cell (PSCell) and secondary cells (SCells). The assumption is to reuse SCell failure reporting for beam failure (BF).

Besides, there is a baseline mechanism, in which further enhancements is not precluded: a “threshold” for the maximum number of LBT failures which triggers the “consistent” LBT failure event will be used; both a timer and a counter are introduced, the counter is reset when timer expires and incremented when UL LBT failure happens; the timer is started/restarted when UL LBT failure occurs.

From above description, it is observed that a new mechanism at the MAC layer should be designed to handle consistent UL LBT failures. Both a timer and a counter need to be introduced in the new mechanism for triggering of a consistent UL LBT failure event.

The MAC entity may be configured by RRC with a consistent LBT failure recovery procedure. Consistent LBT failure is detected by counting LBT failure indications, for all UL transmissions, from the lower layers to the MAC entity.

RRC may configure the following parameters in the lbt-FailureRecoveryConfig described in 3GPP TS 38.321 V15.7.0, which is cited here:

lbt-FailurelnstanceMaxCount for the consistent LBT failure detection;

lbt-FailureDetectionTimer for the consistent LBT failure detection;

The following UE variables are used for the consistent LBT failure detection procedure:

LBT_COUNTER: counter for LBT failure indication which is initially set to 0.

The MAC entity shall:
1> if LBT failure indication has been received from lower layers:
   2> start or restart the lbt-FailureDetectionTimer;
   2> increment LBT_COUNTER by 1;
   2> if LBT_COUNTER>=lbt-FailurelnstanceMaxCount:
      3> initiate [a recovery mechanism (FFS)]
1> if the lbt-FailureDetectionTimer expires; or
[1> if lbt-FailureDetectionTimer or lbt-FailurelnstanceMaxCount is reconfigured by upper layers:]
   2> set LBT_COUNTER to 0.
[1> if the recovery mechanism (FFS) is successful:
   2> set LBT_COUNTER to 0;
   2> consider the LBT Failure Recovery procedure successfully completed.]

Furthermore, a new MAC CE may be introduced to report occurrence of consistent uplink LBT failures in an SCell. That is to say, when consistent uplink LBT failures are detected on an SCell, the new MAC CE will be used to report this to the node (e.g. gNB) where SCell belongs to, and the MAC CE may be used to report failure on primary cell (PCell).

Besides, a new MAC CE should be designed for indicating a beam failure recovery request (BFRQ) in an SCell. More specifically, on BFRQ procedure for SCell, the indicator on a BFRQ in an SCell can be carried by at least a dedicated SR-like PUCCH resource for BFR over PCell or PSCell, but whether or not the indicator on a BFRQ in an SCell can be carried by a MAC CE in a PUSCH transmission need to be further studied.

For NR-U, additional functionality beyond the specifications for operation in licensed spectrum in the following deployment scenarios should be further studied: carrier aggregation between licensed band NR (PCell) and NR-U (SCell); NR-U SCell may have both DL and UL, or DL-only; dual connectivity between licensed band LTE (PCell) and NR-U (PSCell); stand-alone NR-U; an NR cell with DL in unlicensed band and UL in licensed band; dual connectivity between licensed band NR (PCell) and NR-U (PSCell).

NR unlicensed operation needs to support both standalone and dual connectivity (DC) scenarios meaning that both RACH and PUCCH-SR signaling need to be transmitted in unlicensed spectrum cells, since a NR-U cell may operate as a primary cell. At the same time, the radio link monitoring function should be also defined by reusing the same mechanism as in NR licensed, where SSB or CSI-RS can be configured for radio link monitoring (RLM) purpose. Prior to any uplink or downlink transmission, an LBT operation must be performed in order to grasp a channel.

In one case, an NR-U UE may experience consecutive LBT failures during uplink transmissions such as PRACH, or PUCCH-SR, sounding or data transmission. In another case, a gNB may experience consecutive LBT failures for DL transmissions such as dedicated RS (DRS), physical downlink control channel (PDCCH) or data. It is expected that it is beneficial to not impact existing MAC/radio link control (RLC) counters by LBT failures. Otherwise, the on-going transmission or procedures may get stalled or delayed. The root cause for LBT failures is due to system congestion. The best solution for a UE would be to change its serving BWP/cell/carrier to another BWP/cell/carrier with lower congestion quickly to recover from the LBT failures.

As described above, there are two different requests for defining new messages, such as signaling, or MAC subheaders and/or MAC CEs, to report the failure event(s). Although the requests are different, the information content that the new MAC subheaders and/or MAC CEs carry may be partly same, since both MAC subheader and/or MAC CEs are applicable to the same deployment scenario (i.e., dual connectivity or carrier aggregation). As a summary, there are several remaining issues to be addressed:

Issue 1: what information fields need to be carried by the new MAC subheader and/or MAC CE?

Issue 2: how to define the same MAC subheader and/or MAC CE format for the two different requests?

Issue 3: how to also apply the same MAC subheader and/or MAC CE for reporting consistent LBT failures in primary cells, e.g. PCell or PSCell)?

Issue 4: the MAC subheader and/or MAC CE is able to indicate consistent UL LBT failures in a BWP of an SCell, when all configured BWPs of the SCell in which consistent LBT failures are detected, what will be the UE behaviors?

Therefore, one of the objects of the disclosure is to provide solutions to solve at least one of the above issues.

According to a first aspect of the disclosure, there is provided a method implemented at a terminal device. The method comprises determining a message including at least one indication which indicates at least one failure event. The method further comprises transmitting the message to a network node. The message comprises a medium access control (MAC) control element (CE) and the consistent LBT failure is associated with one or multiple cells.

In this way, the failure event(s) can be reported to the network node.

In an embodiment of the disclosure, the consistent LBT failure is associated with one or multiple cells further comprises that the consistent LBT failure is detected in one or multiple cells.

In an embodiment of the disclosure, the indication comprises one or more bits in the MAC CE.

In an embodiment of the disclosure, the indication comprises a bitmap indicating a presence or absence of the consistent LBT failure.

In an embodiment of the disclosure, the indication comprises a bitmap indicating cells where the consistent LBT failure is present or absent.

In an embodiment of the disclosure, the indication indicating a cell associated with the consistent LBT failure.

In an embodiment of the disclosure, the cell comprises a Special Cell (SpCell), or a secondary cell (SCell).

In an embodiment of the disclosure, when the consistent LBT failure is detected in one or multiple cells, the consistent LBT failure is reported in different cells via the message.

According to a second aspect of the disclosure, there is provided a method implemented at a network node. The method comprises receiving a message including at least one indication which indicates at least one failure event from a terminal device. The method further comprises obtaining the failure event according to indication in the message. The message comprises a medium access control (MAC) control element (CE), and the consistent LBT failure is associated with one or multiple cells.

In this way, the failure event(s) can be obtained from the terminal device.

In an embodiment of the disclosure, the consistent LBT failure is associated with one or multiple cells further comprises that the consistent LBT failure is detected in one or multiple cells.

In an embodiment of the disclosure, the indication comprises one or more bits in the MAC CE.

In an embodiment of the disclosure, the indication comprises a bitmap indicating a presence or absence of the consistent LBT failure.

In an embodiment of the disclosure, the indication comprises a bitmap indicating cells where the consistent LBT failure is present or absent.

In an embodiment of the disclosure, the indication indicating a cell associated with the consistent LBT failure.

In an embodiment of the disclosure, the cell comprises a Special Cell (SpCell), or a secondary cell (SCell).

In an embodiment of the disclosure, when the consistent LBT failure is detected in one or multiple cells, the consistent LBT failure is reported in different cells via the message.

According to a third aspect of the disclosure, there is provided an apparatus implemented in a terminal device. The apparatus comprises one or more processors and one or more memories. The one or more memories comprises computer program codes. The one or more memories and the computer program codes are configured to, with the one or more processors, cause the apparatus at least to determine a message including at least one indication which indicates at least one failure event and transmit the message to a network node. The message comprises a medium access control (MAC) control element (CE), and the consistent LBT failure is associated with one or multiple cells.

In an embodiment of the disclosure, the apparatus implemented in the terminal device is operative to perform the method according to the above first aspect.

According to a fourth aspect of the disclosure, there is provided an apparatus implemented in a network node. The apparatus comprises one or more processors and one or more memories. The one or more memories comprises computer program codes. The one or more memories and the computer program codes are configured to, with the one or more processors, cause the apparatus at least to receive a message including at least one indication which indicates at least one failure event from a terminal device and obtain the failure event according to indication in the message. The message comprises a medium access control (MAC) control element (CE), and the consistent LBT failure is associated with one or multiple cells.

In an embodiment of the disclosure, the apparatus implemented in the network node is operative to perform the method according to the above second aspect.

According to a fifth aspect of the disclosure, there is provided a computer program product. The computer program product comprises instructions which when executed by at least one processor, cause the at least one processor to perform the method according to the above first or second aspect.

According to a sixth aspect of the disclosure, there is provided a computer-readable storage medium. The computer readable storage medium comprises computer program codes. The computer program codes comprise codes for performing the method according to the above first or second aspect.

According to a seventh aspect of the disclosure, there is provided a method implemented at a terminal device. The method comprises determining a message including at least one indication which indicates at least one failure event. The method further comprises transmitting the message to a network node.

In this way, the failure event(s) can be reported to the network node.

In an embodiment of the disclosure, the failure event comprises at least one of consistent listen before talk (LBT) failures or a beam failure.

In an embodiment of the disclosure, the message comprises at least one of: a medium access control (MAC) subheader, a MAC control element (CE), a radio resource control (RRC) signaling, a physical uplink control channel (PUCCH) signaling, or a signaling in random access channel (RACH) procedure.

In an embodiment of the disclosure, the failure event is associated with at least one of: a cell, a bandwidth part (BWP) or a beam.

In an embodiment of the disclosure, the failure event is associated with at least one of: a cell, a BWP, or a beam further comprises: the failure event is detected in one or multiple cells/BWPs/beams; or the terminal device prefers to switch to one or multiple cells/BWPs/beams due to the failure event.

In an embodiment of the disclosure, the indication comprises one or more bits in at least one of: a MAC subheader, a logical channel ID (LCID), or a MAC CE.

In an embodiment of the disclosure, the indication comprises a bitmap indicating a presence or absence of the failure event, or indicating cells/BWP/beams where the failure event is present or absent.

In an embodiment of the disclosure, the indication comprises an index of at least one of a cell, a BWP, or a beam associated with the failure event.

In an embodiment of the disclosure, the cell comprises a primary cell (PCell), a secondary cell (SCell), or a primary secondary cell (PSCell).

In an embodiment of the disclosure, when the failure event is detected in one or multiple cells/BWPs/beams, the failure event is reported in same or different cells/BWPs/beams via the message.

According to a eighth aspect of the disclosure, there is provided a method implemented at a network node. The method comprises receiving a message including at least one indication which indicates at least one failure event from a terminal device. The method further comprises obtaining the failure event according to indication in the message.

In this way, the failure event(s) can be obtained from the terminal device.

In an embodiment of the disclosure, the method further comprises performing a recovery action based on the failure event.

In an embodiment of the disclosure, the failure event comprises at least one of consistent listen before talk (LBT) failures or a beam failure.

In an embodiment of the disclosure, the message comprises at least one of: a medium access control (MAC) subheader, a MAC control element (CE), a radio resource control (RRC) signaling, a physical uplink control channel (PUCCH) signaling, or a signaling in random access channel (RACH) procedure.

In an embodiment of the disclosure, the failure event is associated with at least one of: a cell, a bandwidth part (BWP) or a beam.

In an embodiment of the disclosure, the failure event is associated with at least one of: a cell, a BWP, or a beam further comprises: the failure event is detected in one or multiple cells/BWPs/beams; or the terminal device prefers to switch to one or multiple cells/BWPs/beams due to the failure event.

In an embodiment of the disclosure, the indication comprises one or more bits in at least one of: a MAC subheader, a logical channel ID (LCID), or a MAC CE.

In an embodiment of the disclosure, the indication comprises a bitmap indicating a presence or absence of the failure event, or indicating cells/BWP/beams where the failure event is present or absent.

In an embodiment of the disclosure, the indication comprises an index of at least one of a cell, a BWP, or a beam associated with the failure event.

In an embodiment of the disclosure, the cell comprises a primary cell (PCell), a secondary cell (SCell), or a primary secondary cell (PSCell).

In an embodiment of the disclosure, when the failure event is detected in one or multiple cells/BWPs/beams, the failure event is reported in same or different cells/BWPs/beams via the message.

According to a ninth aspect of the disclosure, there is provided an apparatus implemented in a terminal device. The apparatus comprises one or more processors and one or more memories. The one or more memories comprises computer program codes. The one or more memories and the computer program codes are configured to, with the one or more processors, cause the apparatus at least to determine a message including at least one indication which indicates at least one failure event and transmit the message to a network node.

In an embodiment of the disclosure, the apparatus implemented in the terminal device is operative to perform the method according to the above seventh aspect.

According to a tenth aspect of the disclosure, there is provided an apparatus implemented in a network node. The apparatus comprises one or more processors and one or more memories. The one or more memories comprises computer program codes. The one or more memories and the computer program codes are configured to, with the one or more processors, cause the apparatus at least to receive a message including at least one indication which indicates at least one failure event from a terminal device and obtain the failure event according to indication in the message.

In an embodiment of the disclosure, the apparatus implemented in the network node is operative to perform the method according to the above eighth aspect.

According to a eleventh aspect of the disclosure, there is provided a computer program product. The computer program product comprises instructions which when executed by at least one processor, cause the at least one processor to perform the method according to the above seventh or eighth aspect.

According to a twelfth aspect of the disclosure, there is provided a computer-readable storage medium. The computer readable storage medium comprises computer program codes. The computer program codes comprise codes for performing the method according to the above seventh or eighth aspect.

According to a thirteenth aspect of the disclosure, there is provided an apparatus implemented in a terminal device. The apparatus comprises a determination module for determining a message including at least one indication which indicates at least one failure event. The apparatus further comprises a transmitting module for transmitting the message to a network node. The message comprises a medium access control (MAC) control element (CE) and the consistent LBT failure is associated with one or multiple cells.

According to a fourteenth aspect of the disclosure, there is provided apparatus implemented in a network node. The apparatus comprises a receiving module for receiving a message including at least one indication which indicates at least one failure event from a terminal device. The apparatus further comprises an obtaining module for obtaining the failure event according to indication in the message. The message comprises a medium access control (MAC) control element (CE) and the consistent LBT failure is associated with one or multiple cells.

According to a fifteenth aspect of the disclosure, there is provided an apparatus implemented in a terminal device. The apparatus comprises a determination module for determining a message including at least one indication which indicates at least one failure event. The apparatus further comprises a transmitting module for transmitting the message to a network node.

According to an sixteenth aspect of the disclosure, there is provided apparatus implemented in a network node. The apparatus comprises a receiving module for receiving a message including at least one indication which indicates at least one failure event from a terminal device. The apparatus further comprises an obtaining module for obtaining the failure event according to indication in the message.

According to a seventeenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the second or eighth aspect of the present disclosure.

According to a eighteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the second or eighth aspect of the present disclosure.

According to an nineteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first or seventh aspect of the present disclosure.

According to a twentieth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first or seventh aspect of the present disclosure.

According to a twenty-first aspect of the present disclosure, there is provided a method implemented in a communication system which may include a host computer, a base station and a UE. The method may comprise, at the host computer, receiving user data transmitted to the base station from the UE which may perform any step of the method according to the first or seventh aspect of the present disclosure.

According to a twenty-second aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first or seventh aspect of the present disclosure.

According to a twenty-third aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the second or eighth aspect of the present disclosure.

According to a twenty-fourth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the second or eighth aspect of the present disclosure.

In this way, the terminal device is able to use signalings or MAC subheader and/or MAC CE to report failure event(s), so the network node could better and faster select proper actions for one or more terminal devices who suffer from the same failure. Thus, it could help terminal devices who are suffering from the same type of the failure event to recover from the failures.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 shows procedures for radio link monitoring of a serving cell followed by RRC re-establishment to a target cell;

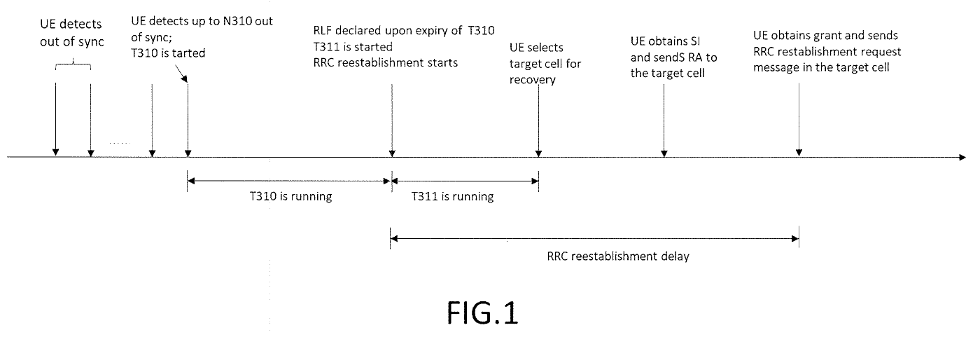

FIGS. 2A-2C show structures of existing MAC subheaders;

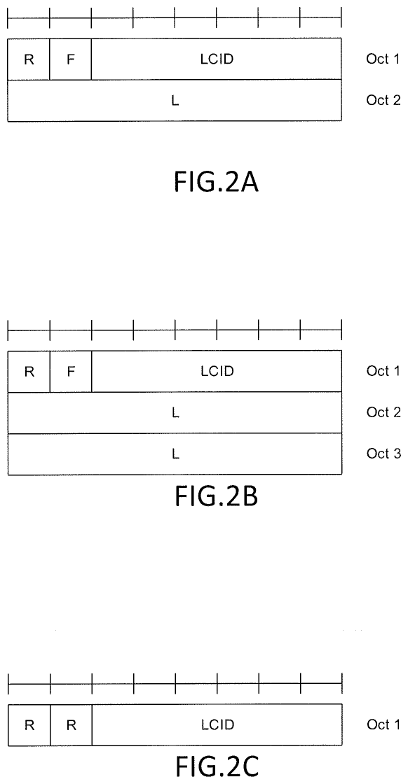

FIG. 3A shows an example of a DL MAC PDU;

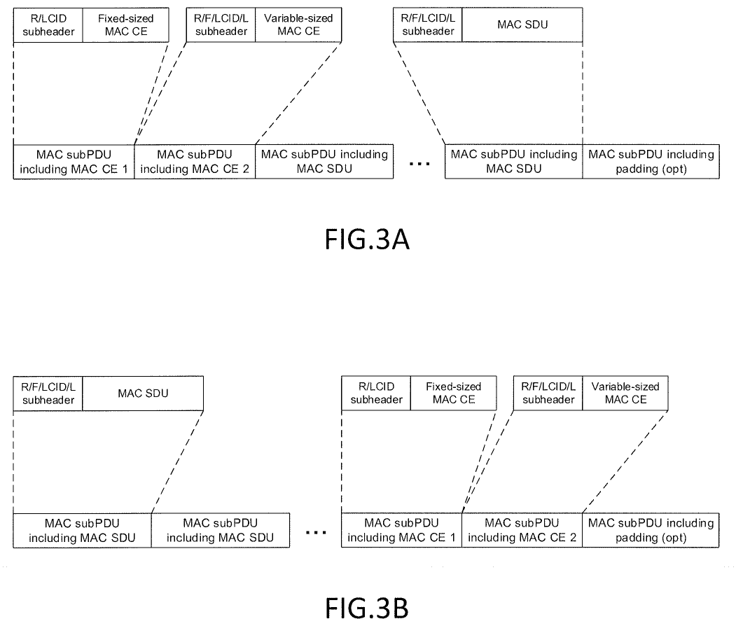

FIG. 3B shows an example of a UL MAC PDU;

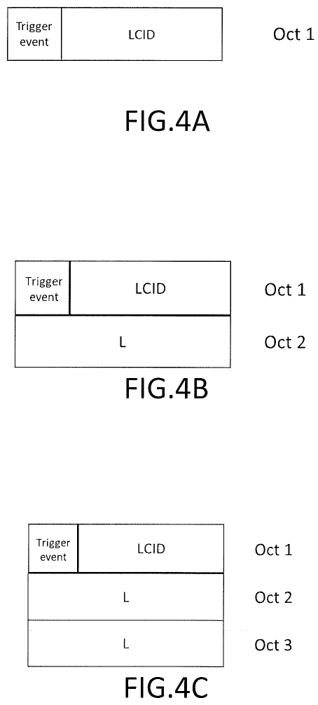

FIGS. 4A-4C show examples of MAC subheaders for an embodiment;

FIGS. 5A-5C show examples of MAC CE for another embodiment;

FIG. 6A-6B are flowcharts illustrating methods implemented at a terminal device according to embodiments of the disclosure;

FIG. 7A-7B are flowcharts illustrating methods implemented at a network node according to embodiments of the disclosure;

FIG. 8 is a block diagram showing an apparatus suitable for use in practicing some embodiments of the disclosure;

FIG. 9 is a block diagram showing an apparatus implemented in a terminal device according to an embodiment of the disclosure;

FIG. 10 is a block diagram showing an apparatus implemented in a network node according to an embodiment of the disclosure;

FIG. 11 is a block diagram illustrating a telecommunication network connected via an intermediate network to a host computer in accordance with some embodiments of the present disclosure;

FIG. 12 is a block diagram illustrating a host computer communicating via a base station with a UE over a partially wireless connection in accordance with some embodiments of the present disclosure;

FIG. 13 is a flowchart illustrating a method implemented in a communication system, in accordance with an embodiment of the present disclosure;

FIG. 14 is a flowchart illustrating a method implemented in a communication system, in accordance with an embodiment of the present disclosure;

FIG. 15 is a flowchart illustrating a method implemented in a communication system, in accordance with an embodiment of the present disclosure; and

FIG. 16 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like. In the following description, terms “terminal device” and “UE” will be used interchangeably.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

The present disclosure proposes solutions to allow a terminal device, such as a UE, to provide a failure report using a signaling or MAC subheader and/or MAC CE to a network node, such as its serving gNB. Then the network is able to take timely actions to reconfigure this or other UEs who may also suffer from the same failure. Both LBT failure event and beam failure event can be reported by the signaling or MAC subheader and/or MAC CE. The proposed mechanism is applicable to both licensed and unlicensed operations, such as licensed assisted access (LAA)/enhanced licensed assisted access (eLAA)/further enhanced LAA (feLAA)/MuLteFire etc.

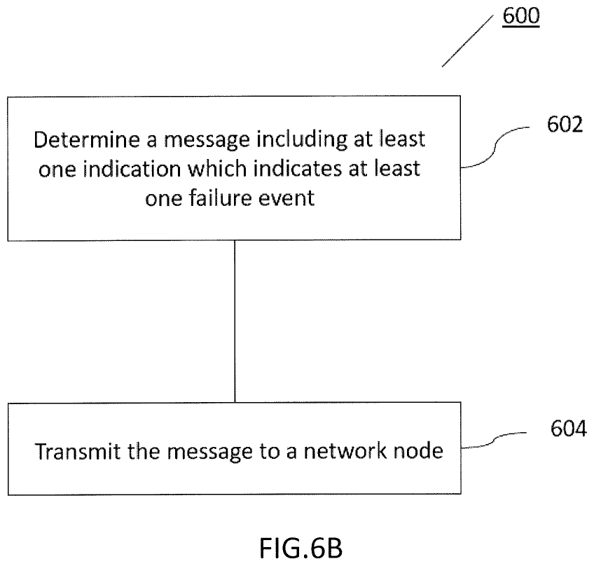

FIG. 6A is a flowchart illustrating a method 600′ according to some embodiments of the present disclosure. The method 600′ illustrated in FIG. 6A may be performed by an apparatus implemented in a terminal device or communicatively coupled to a terminal device. In accordance with an exemplary embodiment, the terminal device such as a UE can determine a message including at least one indication which indicates consistent listen before talk (LBT) failure, as illustrated in block 602′. The message may comprise a medium access control (MAC) control element (CE), and the consistent LBT failure is associated with one or multiple cells, e.g. the consistent LBT failure is detected in one or multiple cells.

According to the exemplary method 600′ illustrated in FIG. 6A, the terminal device such as a UE can transmit the message to a network node, as illustrated in block 604′.

In accordance with an exemplary embodiment, the indication may comprise one or more bits in the MAC CE, or comprise a bitmap indicating a presence or absence of the consistent LBT failure or indicating cells where the consistent LBT failure is present or absent, the indicating could be explicitly or implicitly.

In accordance with an exemplary embodiment, the indication may indicate one or multiple cells associated with the consistent LBT failure.

In accordance with an exemplary embodiment, the cell can be a Special Cell (SpCell), or a secondary cell (SCell).

In accordance with an exemplary embodiment, when the consistent LBT failure is detected in one or multiple cells, the consistent LBT failure can be reported in different cells via the message.

As a specific embodiment, a generic MAC CE may be defined for reporting all trigger events that are described above, the trigger event could be indicated via a field in the MAC CE payload.

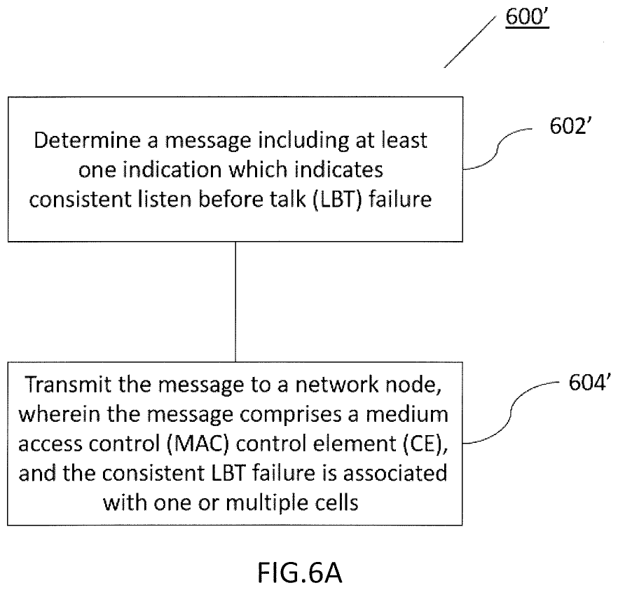

In one example, as shown in FIG. 5A, there are three fields defined to indicate the identity of the serving cell, the identity of the BWP, the type of the trigger event respectively. In the indicated serving cell and the BWP, the indicated event has been triggered. In FIG. 5A, the trigger event occupies 2 bits. It is also possible to occupy more or fewer bits depending on how many trigger events need to be reported.

In one example, as shown in FIG. 5B, the UE may also indicate a beam in which the UE has detected the failure. The beam may be indicated via an index of the beam, or an index of the SSB or CSI-RS resource which is associated with the beam. In this figure, the beam index occupies 4 bits. It is also possible to occupy more or fewer bits depending on how many beams that are configured.

In one example, as shown in FIG. 5C, the UE may also indicate a beam, or a BWP or a cell that the UE prefers to switch to upon detection of a failure in the current beam, or serving BWP or serving cell. Also, as shown in FIG. 5C, the UE indicates a candidate beam that the UE prefers to switch to. In this example, it is only an index for a candidate beam in the same cell and the same BWP that is included in the MAC CE. If the UE prefers to switch to another cell or another BWP, the MAC CE would also carry an additional index for another cell or another BWP.

In one example, there may be more fields to indicate the identities for multiple serving cells in the MAC CE. This means that the UE can report failure events for multiple cells at the same time.

In one example, there may be multiple fields for trigger events in the MAC CE. In this way, the UE can report multiple different failure events at the same time.

In another example, a bitmap field may be defined in the MAC CE to indicate the presence or absence of a trigger event for cells. Each position in the bitmap corresponds to a cells. For example, a bitmap field set to 1 indicates that a trigger event for the corresponding cell is detected, a bitmap field set to 0 indicates that a trigger event for the corresponding cell is not detected.

Additionally, the MAC CE may also include bitmap fields for indicating candidate cell for every cell in which the UE has detected a failure event. It is also possible to introduce a bitmap field for indicating multiple trigger events. In one example, some fields in the MAC CE may be not needed.

As a another specific embodiment, a different MAC CE format is defined for reporting a different trigger event. In this case, the trigger event field is not needed in the MAC CE. The similar examples described in the above embodiment are also applicable in this embodiment.

Upon reception of a reporting message, the gNB takes proper recovery actions for the UE respectively.

As described above, the UE can report a failure event using the MAC CE for any cell, including an SCell, a PCell in CA, or SpCell in DC.

In accordance with an exemplary embodiment, when the failure event is detected in one or multiple cells, the failure event is reported in the same or different cells via the message.

In one example, upon detection of a failure event in a Cell, the UE may report the failure event in the same or any other Cell.

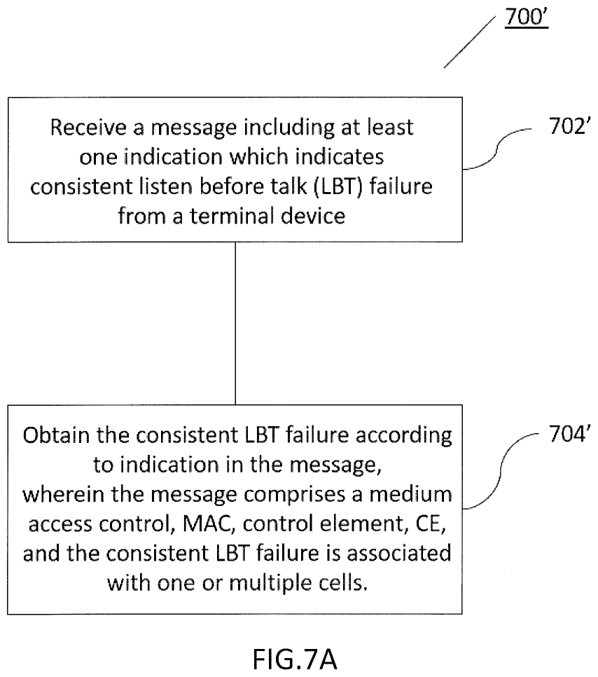

FIG. 7A is a flowchart illustrating a method 700′ according to some embodiments of the present disclosure. As described in connection with FIG. 6A, the method 700′ illustrated in FIG. 7A may be performed by an apparatus implemented in a network node or communicatively coupled to a network node. In accordance with an exemplary embodiment, the network node such as a gNB may receive a message including at least one indication which indicates at least one failure event from a terminal device, as illustrated in block 702′. The message may comprise a medium access control (MAC) control element (CE), and the consistent LBT failure is associated with one or multiple cells, e.g. the consistent LBT failure is detected in one or multiple cells.

According to the exemplary method 700′ illustrated in FIG. 7A, the network node may further obtain the failure event according to indication in the message, as illustrated in block 704′.

In accordance with an exemplary embodiment, the indication may comprise one or more bits in the MAC CE, or comprise a bitmap indicating a presence or absence of the consistent LBT failure or indicating cells where the consistent LBT failure is present or absent, the indicating could be explicitly or implicitly.

In accordance with an exemplary embodiment, the indication may indicate one or multiple cells associated with the consistent LBT failure.

In accordance with an exemplary embodiment, the cell can be a Special Cell (SpCell), or a secondary cell (SCell).

In accordance with an exemplary embodiment, when the consistent LBT failure is detected in one or multiple cells, the consistent LBT failure can be reported in different cells via the message.

As a specific embodiment, a generic MAC CE may be defined for reporting all trigger events that are described above, the trigger event could be indicated via a field in the MAC CE payload.

In one example, as shown in FIG. 5A, there are three fields defined to indicate the identity of the serving cell, the identity of the BWP, the type of the trigger event respectively. In the indicated serving cell and the BWP, the indicated event has been triggered. In FIG. 5A, the trigger event occupies 2 bits. It is also possible to occupy more or fewer bits depending on how many trigger events need to be reported.

In one example, as shown in FIG. 5B, the UE may also indicate a beam in which the UE has detected the failure. The beam may be indicated via an index of the beam, or an index of the SSB or CSI-RS resource which is associated with the beam. In this figure, the beam index occupies 4 bits. It is also possible to occupy more or fewer bits depending on how many beams that are configured.

In one example, as shown in FIG. 5C, the UE may also indicate a beam, or a BWP or a cell that the UE prefers to switch to upon detection of a failure in the current beam, or serving BWP or serving cell. Also, as shown in FIG. 5C, the UE indicates a candidate beam that the UE prefers to switch to. In this example, it is only an index for a candidate beam in the same cell and the same BWP that is included in the MAC CE. If the UE prefers to switch to another cell or another BWP, the MAC CE would also carry an additional index for another cell or another BWP.

In one example, there may be more fields to indicate the identities for multiple serving cells in the MAC CE. This means that the UE can report failure events for multiple cells at the same time.

In one example, there may be multiple fields for trigger events in the MAC CE. In this way, the UE can report multiple different failure events at the same time.

In another example, a bitmap field may be defined in the MAC CE to indicate the presence or absence of a trigger event for cells. Each position in the bitmap corresponds to a cells. For example, a bitmap field set to 1 indicates that a trigger event for the corresponding cell is detected, a bitmap field set to 0 indicates that a trigger event for the corresponding cell is not detected.

Additionally, the MAC CE may also include bitmap fields for indicating candidate cell for every cell in which the UE has detected a failure event. It is also possible to introduce a bitmap field for indicating multiple trigger events. In one example, some fields in the MAC CE may be not needed.

As a another specific embodiment, a different MAC CE format is defined for reporting a different trigger event. In this case, the trigger event field is not needed in the MAC CE. The similar examples described in the above embodiment are also applicable in this embodiment.

Upon reception of a reporting message, the gNB takes proper recovery actions for the UE respectively.

As described above, the UE can report a failure event using the MAC CE for any cell, including an SCell, a PCell in CA, or SpCell in DC.

In accordance with an exemplary embodiment, when the failure event is detected in one or multiple cells, the failure event is reported in the same or different cells via the message.

In one example, upon detection of a failure event in a Cell, the UE may report the failure event in the same or any other Cell.

In accordance with an exemplary embodiment, the network node may further perform a recovery action based on the failure event.

It will be realized that parameters, variables and settings related to the scheduling and transmission described herein are just examples. Other suitable network settings, the associated configuration parameters and the specific values thereof may also be applicable to implement the proposed methods.

FIG. 6B is a flowchart illustrating a method 600 according to some embodiments of the present disclosure. The method 600 illustrated in FIG. 6B may be performed by an apparatus implemented in a terminal device or communicatively coupled to a terminal device. In accordance with an exemplary embodiment, the terminal device such as a UE can determine a message including at least one indication which indicates at least one failure event, as illustrated in block 602.

According to the exemplary method 600 illustrated in FIG. 6B, the terminal device such as a UE can transmit the message to a network node, as illustrated in block 604.

In accordance with an exemplary embodiment, the failure event may comprise at least one of consistent listen before talk (LBT) failures or a beam failure, and the failure event may be associated with at least one of: a cell, a bandwidth part (BWP) or a beam, which comprises the failure event is detected in one or multiple cells/BWPs/beams, or the terminal device prefers to switch to one or multiple cells/BWPs/beams due to the failure event.

As an example, in order to report different failure events in a cell by a UE to its serving base station, one or multiple new MAC subheaders and/or MAC CEs, are defined as including at least one of below information fields: one or multiple cell/BWP/beam indices in which one or multiple events (for example, consistent LBT failures, or beam failure etc.) have been detected; one or multiple cell/BWP/beam indices in which the UE prefers to switch to. The failure events cover at least one of below: consistent LBT failures, beam failure.

In accordance with an exemplary embodiment, the indication may comprise one or more bits in at least one of: a MAC subheader, a logical channel ID (LCID), or a MAC CE, moreover, the indication may comprise a bitmap indicating the presence or absence of the failure event, or indicating cells/BWP/beams where the failure event is present or absent.

In accordance with an exemplary embodiment the indication may comprise an index of at least one of a cell, a BWP, or a beam associated with the failure event.

As a first embodiment, a generic MAC subheader may be defined for reporting all trigger events that are described above, the trigger event could be indicated via a field in the MAC subheader. A new MAC subheader may be defined accordingly. There are several options to define the new MAC subheader.

Option 1: define a new MAC subheader.

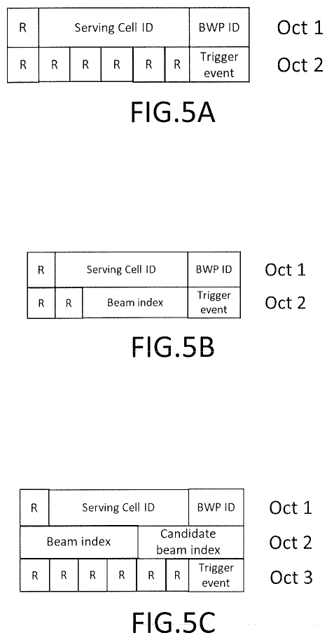

In one example, the MAC CE has a fixed size so that the new MAC subheader doesn't contain a L field for indicating the length for the MAC CE, as shown in FIG. 4A.

In more examples, the MAC CE has a viable size so that the MAC subheader contains a L field for indicating the length for the MAC CE. Two examples are shown in FIG. 4B and FIG. 4C. The L field may be 8 bits or 16 bits.

In above examples, a new LCID may need to be defined for trigger events.

In above examples, the new field “Trigger event” may take different values to represent different types of events that have triggered the MAC CE. For example, the value “00” means that the MAC CE is triggered for reporting consistent LBT failures; the value “01” means that the MAC CE is triggered for beam failure recovery request. In above examples, the field “Trigger event” occupies 2 bits. It is also possible to occupy more or fewer bits which may depend on how many trigger events which need to be reported.

Option 2: introduce multiple LCID values for indicating different trigger events. The new LCID values can be defined in the reserved LCID spaces. In one example, the new LCID values can be introduced in the below table. In this example, the MAC CEs are named as “UL LBT Failure Indication MAC CE” and “BFRQ Indication MAC CE” respectively.

TABLE 4
Values of LCID for UL-SCH

| Index | LCID values |
|---|---|
| 0 | CCCH of size 64 bits (referred to as |
| | “CCCH1” in TS 38.331 [5]) |
| 1-32 | Identity of the logical channel |
| 33 | UL LBT Failure Indication MAC CE |
| 34 | BFRQ Indication MAC CE |
| 35-51 | Reserved |
| 52 | CCCH of size 48 bits (referred to as |
| | “CCCH” in TS 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

As a second embodiment, a generic MAC CE may be defined for reporting all trigger events that are described above, the trigger event could be indicated via a field in the MAC CE payload.

In one example, as shown in FIG. 5A, there are three fields defined to indicate the identity of the serving cell, the identity of the BWP, the type of the trigger event respectively. In the indicated serving cell and the BWP, the indicated event has been triggered. In FIG. 5A, the trigger event occupies 2 bits. It is also possible to occupy more or fewer bits depending on how many trigger events need to be reported.

In one example, as shown in FIG. 5B, the UE may also indicate a beam in which the UE has detected the failure. The beam may be indicated via an index of the beam, or an index of the SSB or CSI-RS resource which is associated with the beam. In this figure, the beam index occupies 4 bits. It is also possible to occupy more or fewer bits depending on how many beams that are configured.

In one example, as shown in FIG. 5C, the UE may also indicate a beam, or a BWP or a cell that the UE prefers to switch to upon detection of a failure in the current beam, or serving BWP or serving cell. Also, as shown in FIG. 5C, the UE indicates a candidate beam that the UE prefers to switch to. In this example, it is only an index for a candidate beam in the same cell and the same BWP that is included in the MAC CE. If the UE prefers to switch to another cell or another BWP, the MAC CE would also carry an additional index for another cell or another BWP.

In one example, there may be more fields to indicate the identities for multiple serving beams/BWPs/cells in the MAC CE. This means that the UE can report failure events for multiple beams/BWPs/cells at the same time. It is also possible that the MAC CE contains only the identity for one serving cell, however, there are identities for multiple BWPs associated with the cell. In this way, the UE can report failure events for multiple BWPs belonging to the same serving cell. It is also possible that the MAC CE contains only the identity for one serving cell or one BWP, however, there are identities for multiple beams belonging to the same cell or BWP. In this way, the UE can report failure events for multiple beams belonging to the same serving cell or the same BWP.

In one example, there may be multiple fields for trigger events in the MAC CE. In this way, the UE can report multiple different failure events at the same time.

In another example, a bitmap field may be defined in the MAC CE to indicate the presence or absence of a trigger event for beams/BWPs/cells. Each position in the bitmap corresponds to a beams/BWPs/cells. For example, a bitmap field set to 1 indicates that a trigger event for the corresponding beam/BWP/cell is detected, a bitmap field set to 0 indicates that a trigger event for the corresponding beam/BWP/cell is not detected.

Additionally, in the same MAC CE, there may be separate bitmap fields to indicate the presence or absence of a trigger event for beams, BWPs or cells respectively. In one example, there is a 4-bits bitmap field, and each bit represents a specific BWP, the bit takes the value “1” indicating occurrence of the failure event in the corresponding BWP, while the bit takes the value “0” indicating that the failure event for the corresponding BWP is not occurring. Similarly, the MAC CE may also include bitmap fields for indicating candidate beam, BWP or cell for every beam, BWP or cell in which the UE has detected a failure event. It is also possible to also introduce a bitmap field for indicating multiple trigger events. In one example, some fields in the MAC CE may be not needed. For example, the BWP index or the beam index indicating the identity of the BWP, or the beam in which the failure has been detected may be not needed in the MAC CE, since the gNB may be aware of the current serving BWP or serving beam for a UE, therefore, it is enough for the UE to send the MAC CE carrying only the cell index and/or the failure event indicator to its gNB.

As a third embodiment, a different MAC CE format is defined for reporting a different trigger event. In this case, the trigger event field is not needed in the MAC CE. The similar examples described in the second embodiment are also applicable in this embodiment.

In accordance with an exemplary embodiment, the message may be one of the following: a medium access control (MAC) subheader, a MAC control element (CE), a radio resource control (RRC) signaling, a physical uplink control channel (PUCCH) signaling, or a signaling in random access channel (RACH) procedure.

In accordance with an exemplary embodiment the cell comprises a primary cell (PCell), a secondary cell (SCell), or a primary secondary cell (PSCell).

As a fourth embodiment, for every detected event, the event may be handled by the UE differently depending on how the event is detected. In case the event is detected in a beam, the UE reports occurrence of the event for the beam to the base station. In case the event is detected in a BWP, the UE reports occurrence of the event for the BWP to the base station. In case the event is detected for all configured BWPs in a serving cell, the UE reports occurrence of the event for the cell to the base station. Alternatively, the gNB configures a number/threshold to limit a UE to report BWP specific failure event, in other words, if the number of detected BWP specific failure events has reached that threshold, the UE reports the event for the cell to the base station.

In the reporting procedure, the UE may use the MAC subheadeer and/or MAC CE to send report to the base station. The UE may also report occurrence of the event using other signaling means such as RRC signaling or PUCCH signaling, or a PRACH procedure which indicates occurrence of the event for the cell.

In an example, the UE may use the MAC subheadeer and/or MAC CE to report all described events in the above embodiments. In another example, the UE uses the MAC CE to report events when the events are detected in a beam or in a BWP, however, the UE uses an RRC signaling to report the event that have been detected for a cell, since the gNB may order the UE to switch to another cell upon reception of the failure report. For such recovery action, RRC signaling may be more suitable due to that RRC signaling gives better transmission reliability than the MAC CE. Specifically, for a failure event detected in an SCell, the UE first uses the MAC CE to report a detected failure for a beam or a BWP, after the same failure event has been detected in all configured BWPs in that SCell, the UE sends an RRC signaling over another cell (e.g., primary cell) reporting the failure event to the base station. The RRC signaling may be a new signaling message or an existing signaling message extended with new information.

Upon reception of a reporting message, the gNB takes proper recovery actions for the UE respectively.

As described above, the UE can report a failure event using the defined MAC subheader and/or MAC CE for any cell, including an SCell, a PCell in CA, or SpCell in DC.

In accordance with an exemplary embodiment, when the failure event is detected in one or multiple cells/BWPs/beams, the failure event is reported in same or different cells/BWPs/beams via the message.

In one example, upon detection of a failure event in a beam/BWP/Cell, the UE may report the failure event in the same or any other beam/BWP/Cell.

FIG. 7B is a flowchart illustrating a method 700 according to some embodiments of the present disclosure. As described in connection with FIG. 6B, the method 700 illustrated in FIG. 7B may be performed by an apparatus implemented in a network node or communicatively coupled to a network node. In accordance with an exemplary embodiment, the network node such as a gNB may receive a message including at least one indication which indicates at least one failure event from a terminal device, as illustrated in block 702.

According to the exemplary method 700 illustrated in FIG. 7B, the network node may further obtain the failure event according to indication in the message, as illustrated in block 704.

In accordance with an exemplary embodiment, the network node may further perform a recovery action based on the failure event.

In accordance with an exemplary embodiment, the failure event may comprise at least one of consistent listen before talk (LBT) failures or a beam failure, and the failure event may be associated with at least one of: a cell, a bandwidth part (BWP) or a beam, which comprises the failure event is detected in one or multiple cells/BWPs/beams, or the terminal device prefers to switch to one or multiple cells/BWPs/beams due to the failure event. When the failure event is detected in one or multiple cells/BWPs/beams, the failure event may be reported in same or different cells/BWPs/beams via the message.

In accordance with an exemplary embodiment, the message may be one of the following: a medium access control (MAC) subheader, a MAC control element (CE), a radio resource control (RRC) signaling, a physical uplink control channel (PUCCH) signaling, or a signaling in random access channel (RACH) procedure.

In accordance with an exemplary embodiment, the indication may comprise one or more bits in at least one of: a MAC subheader, a logical channel ID (LCID), or a MAC CE, moreover, the indication may comprise a bitmap indicating the presence or absence of the failure event, or indicating cells/BWP/beams where the failure event is present or absent.

In accordance with an exemplary embodiment, the indication may comprise an index of at least one of a cell, a BWP, or a beam associated with the failure event.

In accordance with an exemplary embodiment, the cell may comprise a primary cell (PCell), a secondary cell (SCell), or a primary secondary cell (PSCell).

It will be realized that parameters, variables and settings related to the scheduling and transmission described herein are just examples. Other suitable network settings, the associated configuration parameters and the specific values thereof may also be applicable to implement the proposed methods.

The various blocks shown in FIG. 6A,6B and FIG. 7A,7B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

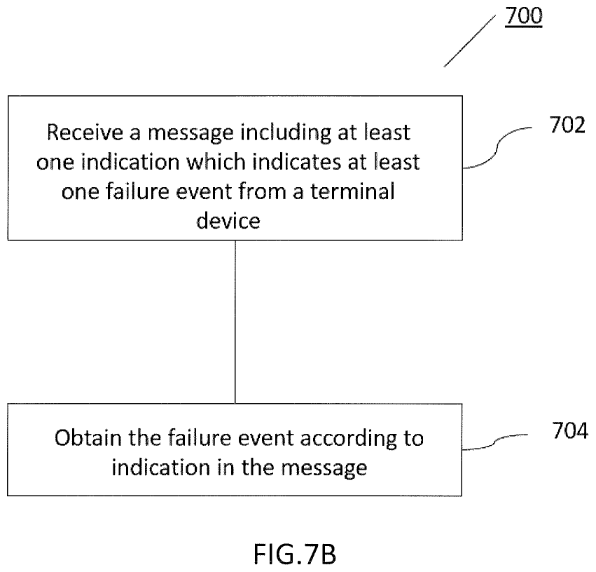

FIG. 8 is a block diagram illustrating an apparatus 800 according to various embodiments of the present disclosure. As shown in FIG. 8, the apparatus 800 may comprise one or more processors such as processor 801 and one or more memories such as memory 802 storing computer program codes 803. The memory 802 may be non-transitory machine/processor/computer readable storage medium. In accordance with some exemplary embodiments, the apparatus 800 may be implemented as an integrated circuit chip or module that can be plugged or installed into a terminal device as described with respect to FIG. 6A or 6B, or a network node as described with respect to FIG. 7A or 7B.

In some implementations, the one or more memories 802 and the computer program codes 803 may be configured to, with the one or more processors 801, cause the apparatus 800 at least to perform any operation of the method as described in connection with FIG. 6A or 6B. In other implementations, the one or more memories 802 and the computer program codes 803 may be configured to, with the one or more processors 801, cause the apparatus 800 at least to perform any operation of the method as described in connection with FIG. 7A or 7B.

Alternatively or additionally, the one or more memories 802 and the computer program codes 803 may be configured to, with the one or more processors 801, cause the apparatus 800 at least to perform more or less operations to implement the proposed methods according to the exemplary embodiments of the present disclosure.

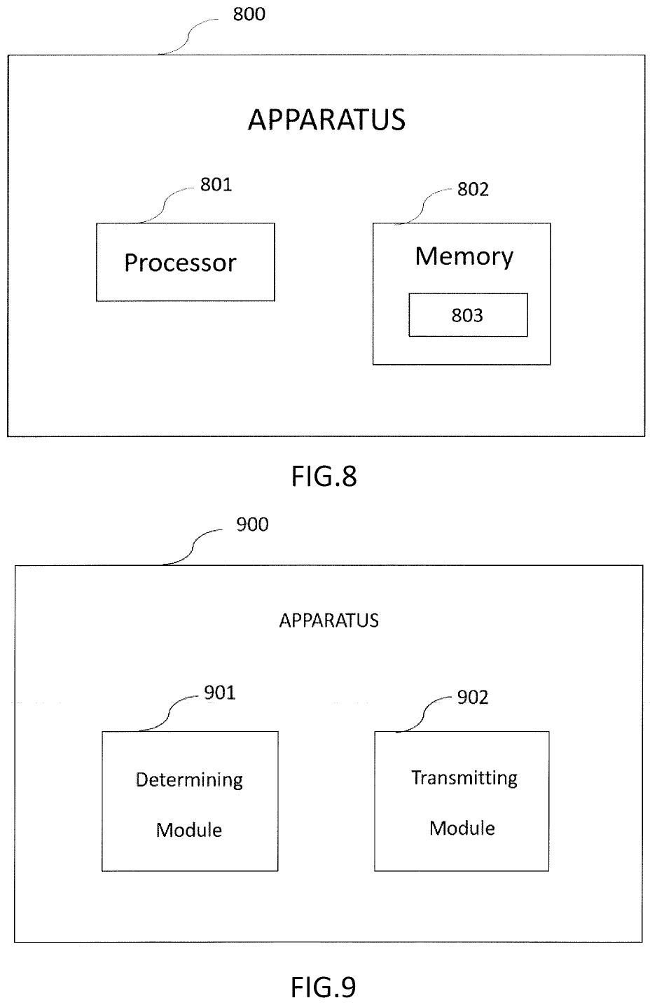

FIG. 9 is a block diagram illustrating an apparatus 900 according to some embodiments of the present disclosure. As shown in FIG. 9, the apparatus 900 may comprise a determining module 901 and a transmitting module 902. In an exemplary embodiment, the apparatus 900 may be implemented in a terminal device such as a UE. The determining module 901 may be operable to carry out the operation in block 602, and the transmitting module 902 may be operable to carry out the operation in block 604. Optionally, the determining module 901 and/or the transmitting module 902 may be operable to carry out more or less operations to implement the proposed methods according to the exemplary embodiments of the present disclosure.

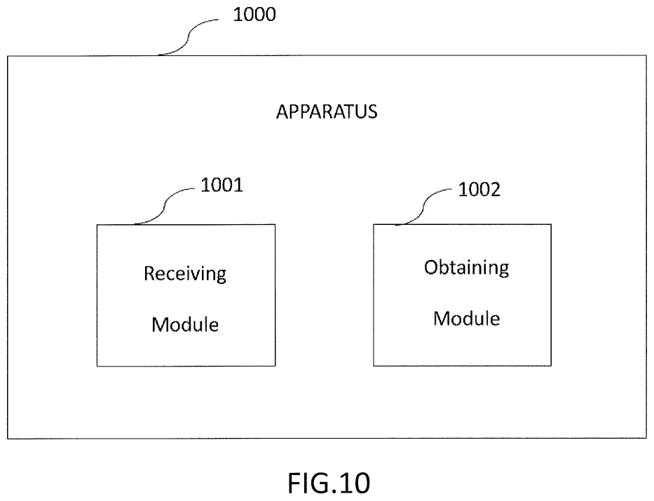

FIG. 10 is a block diagram illustrating an apparatus 1000 according to some embodiments of the present disclosure. As shown in FIG. 10, the apparatus 1000 may comprise a receiving module 1001 and an obtaining module 1002. In an exemplary embodiment, the apparatus 1000 may be implemented in a network node such as a gNB. The receiving module 1001 may be operable to carry out the operation in block 702, and the obtaining module 1002 may be operable to carry out the operation in block 704. Optionally, the receiving module 1001 and/or the obtaining module 1002 may be operable to carry out more or less operations to implement the proposed methods according to the exemplary embodiments of the present disclosure.

In such ways, the proposed solutions enable the network node, e.g. a gNB to better control the performance of the users, or to better utilize the spectrum available. The network node, e.g. a gNB, may receive relevant information about a terminal device, e.g. a UE's detected failure events, so that the network can take appropriate and well-founded actions to deal with problematic situations, and is able to take better and faster actions in response to detected failures. For example, with accurate report on failure reasons, the network may take further actions such as to update RAN configuration for a UE, reconfiguration of a group of UEs with failures to save signaling overhead etc.

A failure report using a signaling or a MAC subheader and/or MAC CE can be triggered earlier than radio link failure (RLF) triggering. Or a UE may switch to another active beam/BWP/cell without triggering an RLF.

Moreover, usage of a specific MAC subheader and/or MAC CE for LBT failures or beam failures can achieve more benefits compared to a pure RRC reestablishment procedure. Compared to pure RRC signaling based reporting means, a MAC subheader and/or MAC CE based reporting gives lower signaling overhead, and faster reaction time.

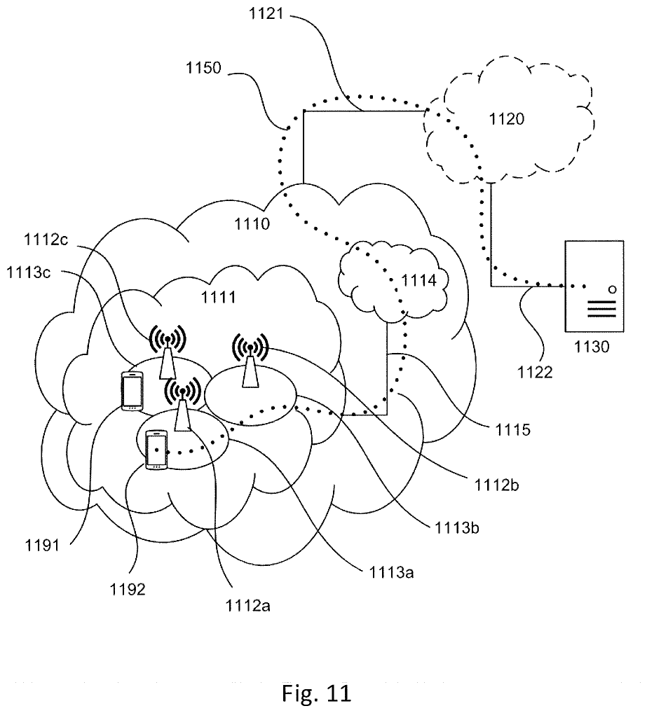

FIG. 11 is a block diagram illustrating a telecommunication network connected via an intermediate network to a host computer in accordance with some embodiments of the present disclosure.

With reference to FIG. 11, in accordance with an embodiment, a communication system includes a telecommunication network 1110, such as a 3GPP-type cellular network, which comprises an access network 1111, such as a radio access network, and a core network 1114. The access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to the core network 1114 over a wired or wireless connection 1115. A first UE 1191 located in a coverage area 1113c is configured to wirelessly connect to, or be paged by, the corresponding base station 1112c. A second UE 1192 in a coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

The telecommunication network 1110 is itself connected to a host computer 1130, which may be embodied in the hardware and/or software of a standalone server, a cloud-implemented server, a distributed server or as processing resources in a server farm. The host computer 1130 may be under the ownership or control of a service provider, or may be operated by the service provider or on behalf of the service provider. Connections 1121 and 1122 between the telecommunication network 1110 and the host computer 1130 may extend directly from the core network 1114 to the host computer 1130 or may go via an optional intermediate network 1120. An intermediate network 1120 may be one of, or a combination of more than one of, a public, private or hosted network; the intermediate network 1120, if any, may be a backbone network or the Internet; in particular, the intermediate network 1120 may comprise two or more sub-networks (not shown).

The communication system of FIG. 11 as a whole enables connectivity between the connected UEs 1191, 1192 and the host computer 1130. The connectivity may be described as an over-the-top (OTT) connection 1150. The host computer 1130 and the connected UEs 1191, 1192 are configured to communicate data and/or signaling via the OTT connection 1150, using the access network 1111, the core network 1114, any intermediate network 1120 and possible further infrastructure (not shown) as intermediaries. The OTT connection 1150 may be transparent in the sense that the participating communication devices through which the OTT connection 1150 passes are unaware of routing of uplink and downlink communications. For example, the base station 1112 may not or need not be informed about the past routing of an incoming downlink communication with data originating from the host computer 1130 to be forwarded (e.g., handed over) to a connected UE 1191. Similarly, the base station 1112 need not be aware of the future routing of an outgoing uplink communication originating from the UE 1191 towards the host computer 1130.

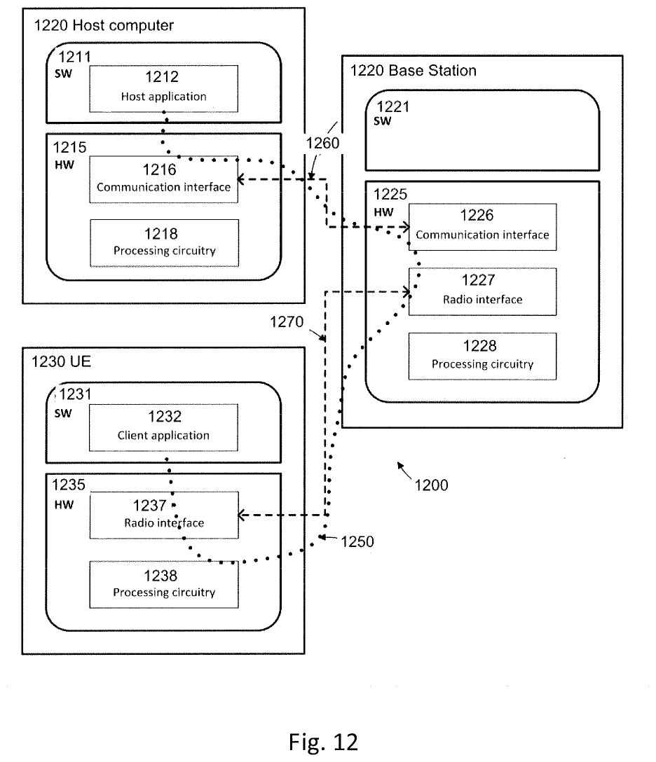

FIG. 12 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 12. In a communication system 1200, a host computer 1210 comprises hardware 1215 including a communication interface 1216 configured to set up and maintain a wired or wireless connection with an interface of a different communication device of the communication system 1200. The host computer 1210 further comprises a processing circuitry 1218, which may have storage and/or processing capabilities. In particular, the processing circuitry 1218 may comprise one or more programmable processors, application-specific integrated circuits, field programmable gate arrays or combinations of these (not shown) adapted to execute instructions. The host computer 1210 further comprises software 1211, which is stored in or accessible by the host computer 1210 and executable by the processing circuitry 1218. The software 1211 includes a host application 1212. The host application 1212 may be operable to provide a service to a remote user, such as UE 1230 connecting via an OTT connection 1250 terminating at the UE 1230 and the host computer 1210. In providing the service to the remote user, the host application 1212 may provide user data which is transmitted using the OTT connection 1250.

The communication system 1200 further includes a base station 1220 provided in a telecommunication system and comprising hardware 1225 enabling it to communicate with the host computer 1210 and with the UE 1230. The hardware 1225 may include a communication interface 1226 for setting up and maintaining a wired or wireless connection with an interface of a different communication device of the communication system 1200, as well as a radio interface 1227 for setting up and maintaining at least a wireless connection 1270 with the UE 1230 located in a coverage area (not shown in FIG. 12) served by the base station 1220. The communication interface 1226 may be configured to facilitate a connection 1260 to the host computer 1210. The connection 1260 may be direct or it may pass through a core network (not shown in FIG. 12) of the telecommunication system and/or through one or more intermediate networks outside the telecommunication system. In the embodiment shown, the hardware 1225 of the base station 1220 further includes a processing circuitry 1228, which may comprise one or more programmable processors, application-specific integrated circuits, field programmable gate arrays or combinations of these (not shown) adapted to execute instructions. The base station 1220 further has software 1221 stored internally or accessible via an external connection.

The communication system 1200 further includes the UE 1230 already referred to. Its hardware 1235 may include a radio interface 1237 configured to set up and maintain a wireless connection 1270 with a base station serving a coverage area in which the UE 1230 is currently located. The hardware 1235 of the UE 1230 further includes a processing circuitry 1238, which may comprise one or more programmable processors, application-specific integrated circuits, field programmable gate arrays or combinations of these (not shown) adapted to execute instructions. The UE 1230 further comprises software 1231, which is stored in or accessible by the UE 1230 and executable by the processing circuitry 1238. The software 1231 includes a client application 1232. The client application 1232 may be operable to provide a service to a human or non-human user via the UE 1230, with the support of the host computer 1210. In the host computer 1210, an executing host application 1212 may communicate with the executing client application 1232 via the OTT connection 1250 terminating at the UE 1230 and the host computer 1210. In providing the service to the user, the client application 1232 may receive request data from the host application 1212 and provide user data in response to the request data. The OTT connection 1250 may transfer both the request data and the user data. The client application 1232 may interact with the user to generate the user data that it provides.

It is noted that the host computer 1210, the base station 1220 and the UE 1230 illustrated in FIG. 12 may be similar or identical to the host computer 1230, one of base stations 1212a, 1212b, 1212c and one of UEs 1291, 1292 of FIG. 12, respectively. This is to say, the inner workings of these entities may be as shown in FIG. 12 and independently, the surrounding network topology may be that of FIG. 12.

In FIG. 12, the OTT connection 1250 has been drawn abstractly to illustrate the communication between the host computer 1210 and the UE 1230 via the base station 1220, without explicit reference to any intermediary devices and the precise routing of messages via these devices. Network infrastructure may determine the routing, which it may be configured to hide from the UE 1230 or from the service provider operating the host computer 1210, or both. While the OTT connection 1250 is active, the network infrastructure may further take decisions by which it dynamically changes the routing (e.g., on the basis of load balancing consideration or reconfiguration of the network).

Wireless connection 1270 between the UE 1230 and the base station 1220 is in accordance with the teachings of the embodiments described throughout this disclosure. One or more of the various embodiments improve the performance of OTT services provided to the UE 1230 using the OTT connection 1250, in which the wireless connection 1270 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be optional network functionality for reconfiguring the OTT connection 1250 between the host computer 1210 and the UE 1230, in response to variations in the measurement results. The measurement procedure and/or the network functionality for reconfiguring the OTT connection 1250 may be implemented in software 1211 and hardware 1215 of the host computer 1210 or in software 1231 and hardware 1235 of the UE 1230, or both. In embodiments, sensors (not shown) may be deployed in or in association with communication devices through which the OTT connection 1250 passes; the sensors may participate in the measurement procedure by supplying values of the monitored quantities exemplified above, or supplying values of other physical quantities from which the software 1211, 1231 may compute or estimate the monitored quantities. The reconfiguring of the OTT connection 1250 may include message format, retransmission settings, preferred routing etc.; the reconfiguring need not affect the base station 1220, and it may be unknown or imperceptible to the base station 1220. Such procedures and functionalities may be known and practiced in the art. In certain embodiments, measurements may involve proprietary UE signaling facilitating the host computer 1210's measurements of throughput, propagation times, latency and the like. The measurements may be implemented in that the software 1211 and 1231 causes messages to be transmitted, in particular empty or ‘dummy’ messages, using the OTT connection 1250 while it monitors propagation times, errors etc.

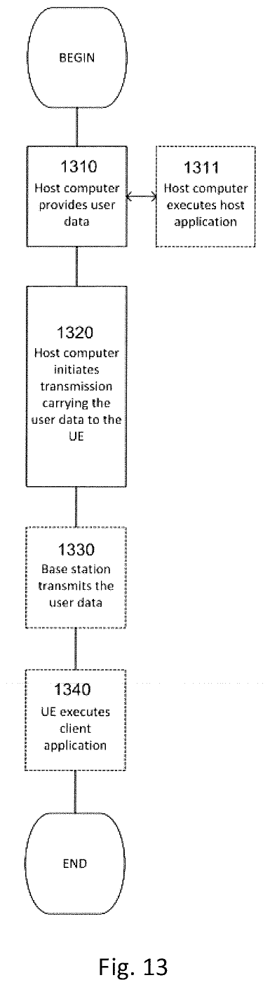

FIG. 13 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 13 will be included in this section. In step 13010, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

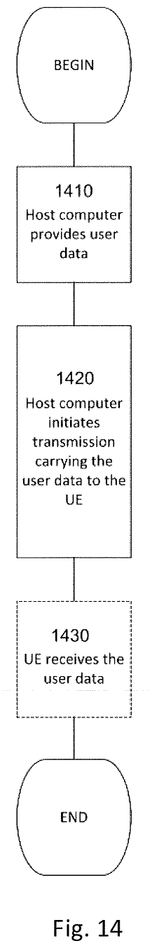

FIG. 14 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

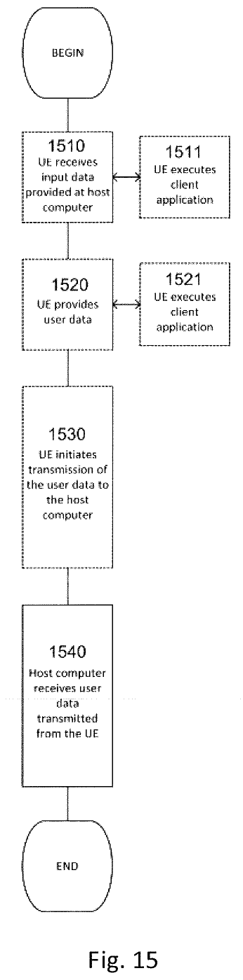

FIG. 15 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

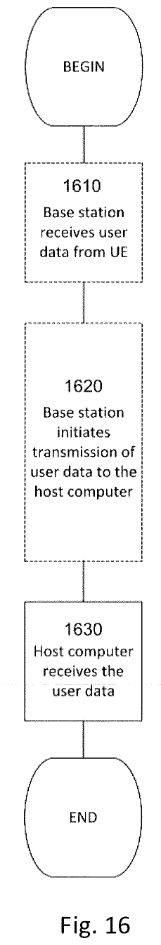

FIG. 16 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1-53. (canceled)

54. A method implemented at a terminal device, comprising:
determining a message including at least one indication which indicates at least one consistent listen before talk, LBT, failure event and the LBT failure event is (ii) associated with a serving cell and a bandwidth part, BWP, wherein the message comprises a medium access control, MAC, subheader and a MAC control element, CE, the indication comprises a bitmap in the MAC CE and the bitmap indicates a presence or absence of the failure event; and
transmitting the message to a network node,
wherein the bitmap field set to 1 indicates that a consistent LBT failure event for the corresponding cell is triggered, the bitmap field set to 0 indicates that a consistent LBT failure for the corresponding cell is not triggered.

55. The method according to claim 54, wherein the failure event is further associated with a beam.

56. The method according to claim 55, wherein the failure event being further associated with a beam further comprises:
the failure event is detected in one or multiple cells/BWPs/beams; or
the terminal device prefers to switch to one or multiple cells/BWPs/beams due to the failure event.

57. The method according to claim 54, wherein the indication comprises one or more bits in at least one of: the medium access control, MAC, subheader, a logical channel ID, LCID, or a MAC CE.

58. The method according to claim 54, wherein the indication comprises an index of at least one of the serving cell, the BWP, or a beam associated with the failure event.

59. The method according to claim 55, wherein the serving cell comprises a primary cell, PCell, a secondary cell, SCell, or a primary secondary cell, PSCell.

60. The method according to claim 56, wherein when the failure event is detected in one or multiple cells/BWPs/beams, the failure event is reported in same or different cells/BWPs/beams via the message.

61. An apparatus implemented in a terminal device, comprising:
one or more processors; and
one or more memories comprising computer program codes,
the one or more memories and the computer program codes configured to, with the one or more processors, cause the apparatus at least to:
determine a message including at least one indication which indicates at least one consistent listen before talk, LBT, failure event and the LBT failure event is (ii) associated with a serving cell and a bandwidth part, BWP, wherein the message comprises a medium access control, MAC, subheader and a MAC control element, CE, the indication comprises a bitmap in the MAC CE and the bitmap indicates a presence or absence of the failure event; and
transmit the message to a network node,
wherein the bitmap field set to 1 indicates that a consistent LBT failure event for the corresponding cell is triggered, the bitmap field set to 0 indicates that a consistent LBT failure for the corresponding cell is not triggered.

62. A method implemented at a network node, comprising:
receiving a message including at least one indication which indicates at least one consistent listen before talk, LBT, failure event and the LBT failure event is (ii) associated with a serving cell and a bandwidth part, BWP, wherein the message comprises a medium access control, MAC, subheader and a MAC control element, CE, the indication comprises a bitmap in the MAC CE and the bitmap indicates a presence or absence of the failure event; and
obtaining the consistent LBT failure event according to indication in the message;
wherein the bitmap field set to 1 indicates that a consistent LBT failure event for the corresponding cell is triggered, the bitmap field set to 0 indicates that a consistent LBT failure for the corresponding cell is not triggered.

63. The method according to claim 62, further comprising:
performing a recovery action based on the failure event.

64. The method according to claim 63, wherein the indication comprises one or more bits in the bitmap.

65. The method according to claim 62, wherein the indication comprises an index of at least one of the serving cell, the BWP, or a beam associated with the failure event.

66. The method according to claim 62, wherein the serving cell comprises a primary cell, PCell, a secondary cell, SCell, or a primary secondary cell, PSCell.

67. The method according to claim 66, wherein when the failure event is detected in one or multiple cells/BWPs/beams, the failure event is reported in same or different cells/BWPs/beams via the MAC CE.

68. An apparatus implemented in a network node, comprising:
one or more processors; and
one or more memories comprising computer program codes,
the one or more memories and the computer program codes configured to, with the one or more processors, cause the apparatus at least to:
receive a message including at least one indication which indicates at least one consistent listen before talk, LBT, failure event and the LBT failure event is (ii) associated with a serving cell and a bandwidth part, BWP, wherein the message comprises a medium access control, MAC, subheader and a MAC control element, CE, the indication comprises a bitmap in the MAC CE and the bitmap indicates a presence or absence of the failure event; and
obtain the consistent LBT failure event according to indication in the message;
wherein the bitmap field set to 1 indicates that a consistent LBT failure event for the corresponding cell is triggered, the bitmap field set to 0 indicates that a consistent LBT failure for the corresponding cell is not triggered.
